(19) United States
(12) Patent Application Publication
(10) Pub. No.: US 2025/0033712 A1
(43) Pub. Date: Jan. 30, 2025

(54) DEVICE FOR REDUCING FLOW RESISTANCE OF A LAND VEHICLE

(71) Applicant: Wolfgang Hermann Sallaberger, Ottensheim (AT)

(72) Inventor: Wolfgang Hermann Sallaberger, Ottensheim (AT)

(21) Appl. No.: 18/712,112

(22) PCT Filed: Nov. 15, 2022
(86) PCT No.: PCT/AT2022/060399

§ 371 Date: May 21, 2024

(30) Foreign Application Priority Data
Nov. 24, 2021 (AT) A 50941/2021

(51) Int. Cl. B62D 35/00

(52) U.S. Cl. CPC B62D 35/001

(57) ABSTRACT

A device for flow resistance reduction has a plurality of airfoil-shaped vortex generators (3a, 3b) arranged on a common carrier (2), wherein the carrier (2) has an attachment surface (4) for the surface of an object. A main vortex generator (3a) is arranged on the side (6) of the carrier (2) opposite the attachment surface (4) along the carrier's axis of symmetry (7). At least one secondary vortex generator (3b) is provided on both sides of the main vortex generator (3a). Particularly favorable conditions reducing flow resistance are created as a result of the auxiliary vortex generators (3b), which are symmetrically opposite one another with respect to the main vortex generator (3a) and extend divergently so as to form a diffusor (9) in the main flow direction (8).

### FIELD OF THE INVENTION

The invention relates to a device for flow resistance reduction with a plurality of airfoil-shaped vortex generators arranged on a common carrier, wherein the carrier has an attachment surface for the surface of an object, wherein a main vortex generator is arranged on the side of the carrier opposite the attachment surface along the carrier's axis of symmetry and wherein at least one auxiliary vortex generator is provided on both sides of the main vortex generator. The device can be used for flow resistance reduction in a fluid, therefore in a gas or in a liquid. Particularly preferably, the device can be used for flow resistance reduction of a land vehicle.

### DESCRIPTION OF THE PRIOR ART

A device for flow resistance reduction of a land vehicle is known from WO2020148216A1. The device has a plurality of vortex generators arranged on a common carrier, which are airfoil-shaped. The vortex generators generate turbulence in a targeted manner as the air flows past, so that the wake in the rear region of the land vehicle, which is upstream in the direction of travel of the land vehicle, is kept small. The disadvantage of this, however, is that specially designed mounting kits are required for the application of the device, so that the device can only be mounted at designated points, for example in the rear region of a truck. In addition, the alignment and dimensions of the device must be adapted to the long vehicle to be equipped. GB2481640A shows a device according to the preamble.

Divergent vortex generators for reducing the noise level of wind turbine rotor blades are known from EP2824320A1.

### SUMMARY OF THE INVENTION

The invention is therefore based on the task of proposing a device of the type described at the beginning, which can be used universally regardless of the type of land vehicle without a loss of flow resistance reduction.

The invention solves the task set by the fact that the auxiliary vortex generators, which are symmetrically opposite one another with respect to the main vortex generator, extend divergently in the main flow direction, forming a diffuser.

As a result of the measures according to the invention, the device can be attached to any part of an object, in particular a land vehicle, in a simple manner via its attachment surface. The attachment surface can, for example, be placed on the surface or integrated into the surface of the object, for example by inserting the attachment surface into a recess in the object. In particular, the attachment surface can be integrated flush into the object so that the attachment surface does not protrude from the surface of the object. According to the invention, a main vortex generator is arranged on the symmetry axis of the carrier and auxiliary vortex generators are arranged on both sides of the main vortex generator. The auxiliary vortex generators, which are symmetrically opposite the main vortex generator, are divergent in the main flow direction, forming a diffuser between the auxiliary vortex generators. Surprisingly, it has been found that the diffuser formed by the auxiliary vortex generators, in whose axis of symmetry the main vortex generator runs, transforms the passing air flow into a particularly stable flow by turbulence, as the turbulence generated by each vortex generator combines to form a common collective vortex. This collective vortex forces the airflow into an air cone that tapers in the main flow direction and is inclined vertically downwards, which can reduce the wake or dead water area at the rear of a land vehicle caused by stall and thus the flow resistance. Although several pairs of—with respect to the main vortex generator—symmetrically divergent running auxiliary vortex generators can be provided, a particularly strong flow resistance reduction is achieved if exactly one auxiliary vortex generator is provided on both sides of the main vortex generator.

Particularly advantageous conditions with regard to stable generation of the collective vortex result if the carrier is symmetrical. Practical attachment conditions can be created if the attachment surface has an adhesive surface for the surface of an object, in particular a land vehicle. The adhesive surface can be formed by the attachment surface of the carrier itself or, for example, by another adapter plate arranged between the carrier and the vehicle surface.

In principle, all vortex generators have an airfoil-shaped form, whereby the profile noses of the vortex generators are positioned in front of the profile trailing edges in the main flow direction. Flow conditions are particularly advantageous if the maximum height of the main vortex generator is lower than the maximum height of the auxiliary vortex generators. The maximum height of the auxiliary vortex generator can preferably be arranged in the first third of the auxiliary vortex generator upstream in the direction of flow. The maximum height of the main vortex generator can be arranged in the middle third of the main vortex generator. The profile nose of the auxiliary vortex generator can have a smaller radius of curvature than the profile spine. The profile nose of the main vortex generator can also have a smaller radius of curvature than the profile spine. The radius of curvature of the profile spine of the auxiliary vortex generator can be larger than the radius of curvature of the profile spine of the main vortex generator.

To stabilize the air flow over the entire longitudinal axis of the device, it is advantageous if the length of the main vortex generator is greater than the length of the auxiliary vortex generators. In particular, if the auxiliary vortex generators are arranged on the carrier set back in the main flow direction with respect to the main vortex generator, the air flow can be divided into two flow areas, each between an auxiliary vortex generator and the main vortex generator, in which turbulence initially forms independently of each other, which mixes in the rear area of the device to form a stable air cone. Particularly stable mixing is achieved if the auxiliary vortex generators are also arranged on the carrier set back against the main flow direction with respect to the main vortex generator. This means that the auxiliary vortex generators do not protrude beyond the main vortex generator either at the front or rear.

In order to minimize carrier-related flow losses despite the simple attachment of the device, it is proposed that the projection surface of the carrier is composed of two fin-shaped partial surfaces formed symmetrically to one another with respect to its axis of symmetry. The fin-shaped partial surfaces are designed in such a way that they form an arc-shaped flow area that is curved in the main flow direction.

Due to the design according to the invention, the invention can be arranged at any location, for example on the hood, at the rear, on the side surfaces and on various surfaces of a superstructure. Depending on the arrangement, different orientations of the vortex generators on the carrier can cause particularly favorable flow conditions. In order to be able to achieve a uniform flow resistance reduction regardless of the actual arrangement of the device, it is proposed that the auxiliary vortex generators enclose an angle of 5° to 25°, in particular of 8° to 18°, with the main vortex generator. Surprisingly, it has been found that at these angles there is a significant improvement in the flow behavior both when the device is arranged in the front region of a land vehicle and in the rear region of a land vehicle.

To ensure that the device can be used over a long period of time regardless of weather or climatic conditions, it is recommended in a particularly robust embodiment of the device according to the invention that the carrier, the main vortex generator and the auxiliary vortex generators are made of an elastomer, in particular PU foam neoprene, rubber or synthetic rubber. Advantageously, the carrier, the main vortex generator and the auxiliary vortex generators can be formed in one piece.

Although it is possible in principle for the device to be placed on any part of a land vehicle via its adhesive surface and fixed in place using conventional fasteners, the fastening conditions are particularly easy to handle if the adhesive surface of the carrier has an adhesive layer.

If the device is used for a land vehicle with a superstructure, advantageous flow conditions result if at least one device is provided in the rear region on the top surface and on the opposite side surfaces of the superstructure. In addition, depending on the design of the land vehicle, devices can also be arranged in the front area of the trailer or on the driver's cab.

### BRIEF DESCRIPTION OF THE INVENTION

The drawing shows an example of the object of the invention, wherein

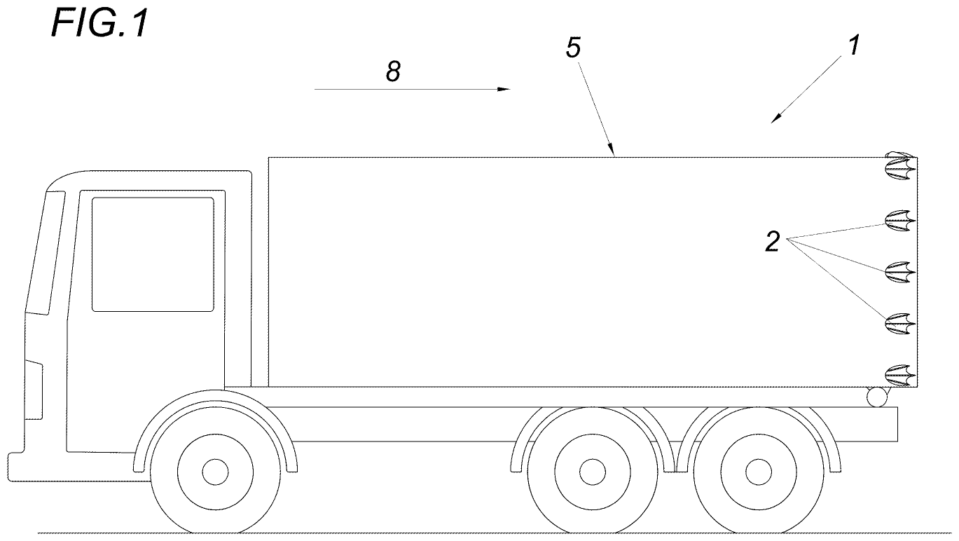

FIG. 1 shows a side view of a land vehicle equipped with devices according to the invention,

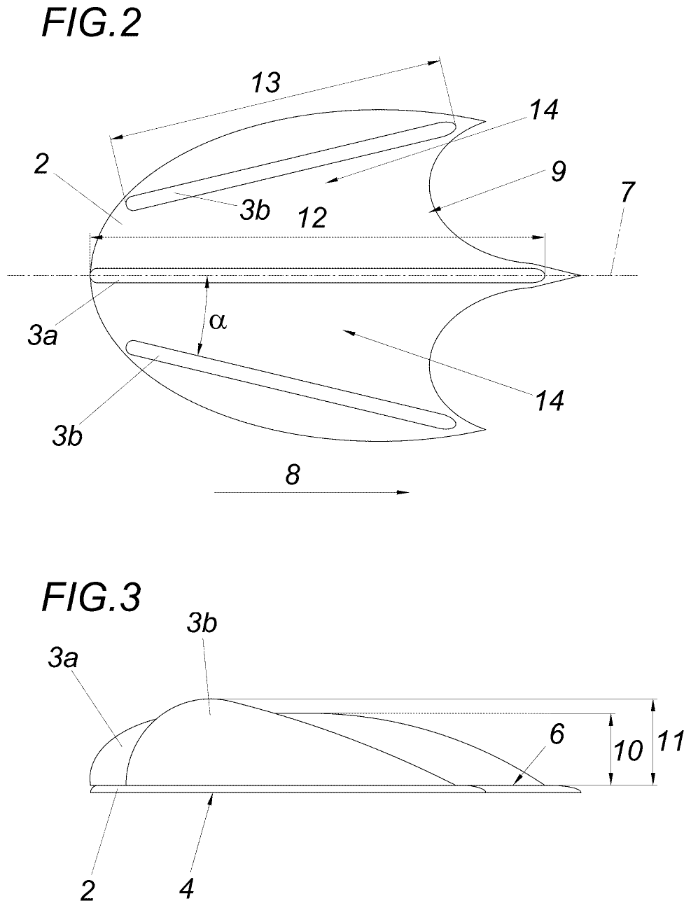

FIG. 2 shows a top view of the device according to the invention on an enlarged scale,

FIG. 3 shows a side view of the device according to the invention,

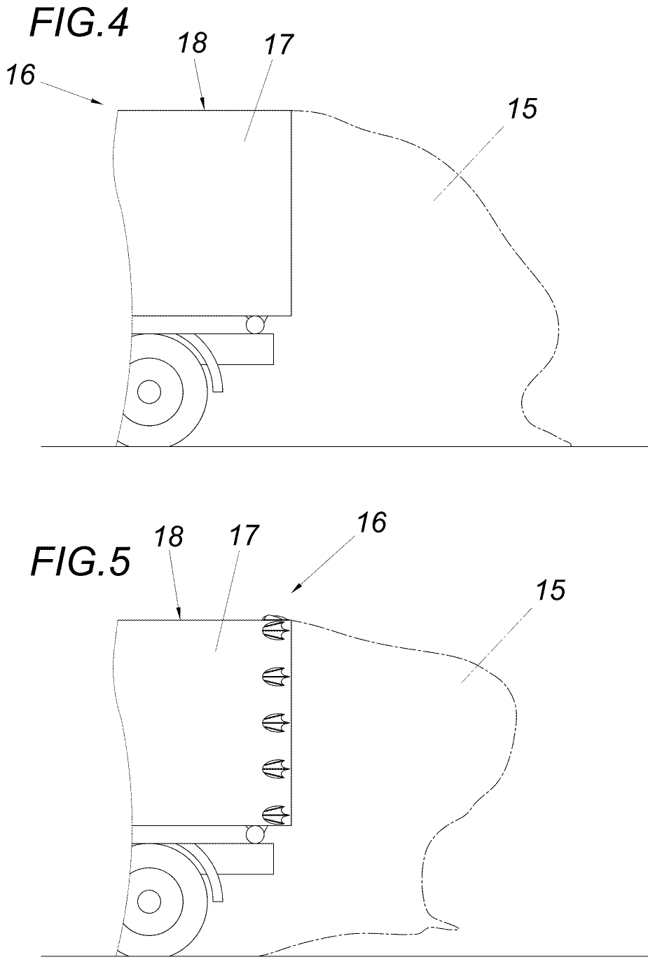

FIG. 4 shows a schematic side view of the wake in the rear region of a trailer of a land vehicle without devices according to the invention,

FIG. 5 shows a schematic side view of the wake in the rear region of a trailer of a land vehicle with devices according to the invention,

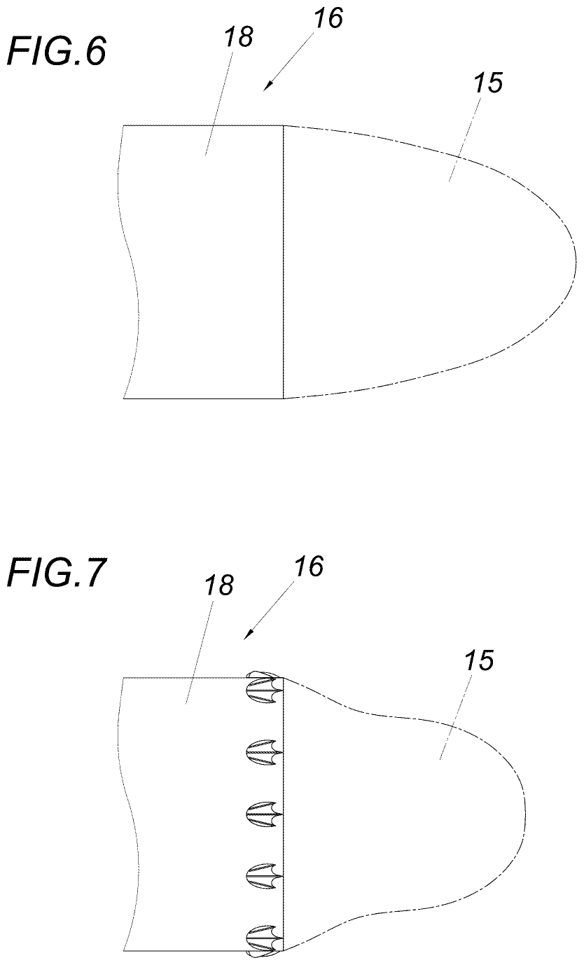

FIG. 6 shows a schematic top view of the wake in the rear region of a trailer of a land vehicle without devices according to the invention and

FIG. 7 shows a schematic top view of the wake in the rear region of a trailer of a land vehicle with devices according to the invention.

### DESCRIPTION OF THE PREFERRED EMBODIMENTS

As can be seen from FIG. 1 and in particular from FIGS. 2 and 3, a device according to the invention for flow resistance reduction of a land vehicle 1 has a carrier 2 on which airfoil-shaped vortex generators 3a, 3b are arranged. The carrier 2 can be symmetrical and can have an attachment surface 4 with an adhesive surface, which is preferably provided with an adhesive layer, for a surface 5 of the land vehicle 1. On the side 6 of the carrier 2 opposite the attachment surface 4, a main vortex generator 3a is provided which runs along the axis of symmetry 7 of the carrier 2. An auxiliary vortex generator 3b is provided on either side of the main vortex generator 3a. These auxiliary vortex generators 3b are symmetrical with respect to the main vortex generator 3a or the axis of symmetry 7 and form a diffuser 9 due to their divergent course in the main flow direction 8.

As shown in FIG. 3, the maximum height 10 of the main vortex generator 3a is lower than the maximum height 11 of the auxiliary vortex generators 3b.

In FIG. 2, it is disclosed that the length 12 of the main vortex generator 3a can be greater than the length 13 of the auxiliary vortex generators. In particular, the auxiliary vortex generators 3b may be arranged set back on the carrier 2 with respect to the main vortex generator 3a in the main flow direction 8. So that such geometries and arrangements can be made on the carrier without greatly increasing carrier-related flow losses, the projection surface of the carrier 2 can be composed of two fin-shaped partial surfaces 14 that are symmetrical with respect to its axis of symmetry 7.

A particularly uniform flow resistance reduction is achieved if the auxiliary vortex generators 3b form an angle α of 13° with the main vortex generator 3a FIGS. 4 and 5 show a comparison of a schematically drawn wake 15 of a superstructure 16 of a land vehicle 1, once without devices according to the invention (FIG. 4) and once with four devices according to the invention each on the side surfaces 17 and on the top surface 18 of the superstructure 16 (FIG. 5). The schematically drawn wake indicates the result of a flow simulation calculation, which shows that the wake 15 of the superstructure 16 equipped with the devices according to the invention is significantly reduced in the rear region, which reduces the drag of the land vehicle 1. A similar reduction in the wake 15 of the superstructure 16 equipped with the devices according to the invention can also be seen from the top view of the superstructure 16 (FIGS. 6 and 7). This is achieved because each device generates a collective vortex which forces the air flow running along the superstructure into a cone of air tapering in the main flow direction 8 and inclined vertically downwards. The calculations carried out as part of the flow simulation have shown that the measures according to the invention have reduced the wake-related flow resistance by 37%. For a truck driving at 100 km/h on an expressway, this would mean a saving of 2 to 3 liters of fuel per 100 km.

1. A device for flow resistance reduction, said device comprising:
a plurality of airfoil-shaped vortex generators arranged on a common carrier;
wherein the carrier has an attachment surface configured to be attached to a surface of an object;
wherein one of the vortex generators is a main vortex generator arranged on a side of the carrier opposite the attachment surface and extends along an axis of symmetry of the carrier; and
wherein the vortex generators include at least two auxiliary vortex generators each provided on a respective side of the main vortex generator; and
wherein the auxiliary vortex generators are supported symmetrically opposite one another with respect to the main vortex generator, and extend divergently in a main flow direction so as to form a diffuser.

2. The device according to claim 1, wherein the carrier is symmetrical and the attachment surface has an adhesive surface configured to adhere to the surface of the object.

3. The device according to claim 1, wherein the main vortex generator has a maximum height and the auxiliary vortex generators have a maximum height, and
wherein the maximum height of the main vortex generator is lower than the maximum height of the auxiliary vortex generators.

4. The device according to claim 1, wherein the main vortex generator has a length that is greater than a length of the auxiliary vortex generators.

5. The device according to claim 1, wherein the auxiliary vortex generators are arranged on the carrier set back in the main flow direction with respect to the main vortex generator.

6. The device according to claim 1, wherein the carrier has a projection surface that is composed of two fin-shaped partial surfaces that are symmetrical to one another with respect to the axis of symmetry.

7. The device according to claim 1, wherein the auxiliary vortex generators enclose an angle of 5° to 25° with the main vortex generator.

8. The device according to claim 1, wherein the carrier, the main vortex generator, and the auxiliary vortex generators are of an elastomer.

9. The device according to claim 2, wherein the adhesive surface of the carrier comprises an adhesive layer configured to provide attachment to a land vehicle.

10. A device according to claim 1, wherein the device is attached to a land vehicle.

11. A land vehicle comprising:
a rectangular superstructure having a top region with a rear region and opposite side surfaces; and
a plurality of devices each according to claim 1, at least one of said devices being supported in the rear region on the top surface, and at least one of said devices being supported on each of the opposite side surfaces of the superstructure.

12. The device according to claim 2, wherein the main vortex generator has a maximum height and the auxiliary vortex generators have a maximum height, and
wherein the maximum height of the main vortex generator is lower than the maximum height of the auxiliary vortex generators.

13. The device according to claim 2, wherein the main vortex generator has a length that is greater than a length of the auxiliary vortex generators.

14. The device according to claim 3, wherein the main vortex generator has a length that is greater than a length of the auxiliary vortex generators.

15. The device according to claim 12, wherein the main vortex generator has a length that is greater than a length of the auxiliary vortex generators.

16. The device according to claim 13, wherein the auxiliary vortex generators are arranged on the carrier set back in the main flow direction with respect to the main vortex generator.

17. The device according to claim 16, wherein the carrier has a projection surface that is composed of two fin-shaped partial surfaces that are symmetrical to one another with respect to the axis of symmetry.

18. The device according to claim 1, wherein the auxiliary vortex generators enclose an angle of 10° to 18° with the main vortex generator.

19. The device according to claim 1, wherein the carrier, the main vortex generator, and the auxiliary vortex generators are of PU foam, neoprene, rubber and/or synthetic rubber.
